(19) United States
(12) Patent Application Publication
(10) Pub. No.: US 2023/0381644 A1
(43) Pub. Date: Nov. 30, 2023

(54) Game Save System and Method

(71) Applicant: Our Machinery, Inc., Issaquah, WA (US)

(72) Inventors: Niklas V. Gray, Issaquah, WA (US); Simon Renger, Breda (NL); Leonardo Lucania, Torino (IT)

(21) Appl. No.: 18/203,794

(22) Filed: May 31, 2023

Related U.S. Application Data
(60) Provisional application No. 63/347,408, filed on May 31, 2022.

(51) Int. Cl. A63F 13/49

(52) U.S. Cl. CPC A63F 13/49

(57) ABSTRACT

A method includes obtaining a gaming application of a device. While executing the gaming application, a user interface that includes a save affordance may be overlaid on the gaming application. In response to detecting a user input directed to the save affordance, state information for the gaming application may be determined. A first portion of the state information may be stored to a data structure during execution of the gaming application and may indicate respective statuses of one or more entities associated with the gaming application that have changed since a previous save. The first portion of the state information that indicates the respective changed statuses of the one or more entities as a representation of the gaming progress of the user may be saved in a non-transitory memory.

### CROSS-REFERENCE TO RELATED APPLICATION

This application claims priority to U.S. Provisional Patent App. No. 63/347,408, filed on May 31, 2022, the disclosure of which is hereby incorporated by reference in its entirety.

### TECHNICAL FIELD

The present disclosure relates to gaming applications, and, in particular, to saving information in gaming applications.

### COPYRIGHT NOTICE

The present disclosure may include material that is subject to copyright protection. The copyright owner has no objection to the facsimile reproduction by anyone of the patent document or the patent disclosure as it appears in the patent files or records of the United States Patent and Trademark Office (USPTO), but otherwise reserves all rights under copyright law.

### BACKGROUND

A gaming application may benefit from the capability to save a game in progress. This enables the user to temporarily stop using the gaming application and later resume the gaming application without losing progress. In some gaming applications, the capability to save a game in progress is tightly tied to a particular gaming application, such that systems that are used to save a game in progress in one gaming application may not be usable to provide similar functionality in a different gaming application.

### SUMMARY

In accordance with some implementations, a method is performed at an electronic device with one or more processors and a non-transitory memory. The method includes tracking a state of a running game application. Changes to the game state may be pushed to a game state subsystem. A user may activate an affordance in a user interface to save the game. In response to the affordance being activated, the game state subsystem may determine whether all changes of the game state have been received by the game state subsystem. If so, the game state subsystem may store the game state to a memory, e.g., the non-transitory memory.

In accordance with some implementations, a method is performed at an electronic device with one or more processors, a display, and a non-transitory memory. The method includes obtaining a gaming application of a device. While executing the gaming application, a user interface that includes a save affordance may be overlaid on the gaming application. In response to detecting a user input directed to the save affordance, state information for the gaming application may be determined. A first portion of the state information may be stored to a data structure during execution of the gaming application and may indicate respective statuses of one or more entities associated with the gaming application that have changed since a previous save. The first portion of the state information that indicates the respective changed statuses of the one or more entities as a representation of the gaming progress of the user may be saved in a non-transitory memory.

In accordance with some implementations, an electronic device may include one or more processors, a non-transitory memory, a display, and one or more programs. The one or more programs may be stored in the non-transitory memory and may be configured to be executed by the one or more processors. The one or more programs may include instructions for obtaining a gaming application of the electronic device. While executing the gaming application, a user interface that includes a save affordance may be overlaid on the gaming application. In response to detecting a user input directed to the save affordance, state information may be determined for the gaming application. A first portion of the state information may indicate respective statuses of one or more entities associated with the gaming application that have changed since a previous save. The first portion of the state information that indicates the respective changed statuses of the one or more entities may be saved in the non-transitory memory as a representation of the gaming progress of the user.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIGS. 1A-1B are diagrams of an example operating environment in accordance with some implementations.

FIG. 2 is a block diagram of a game system in accordance with some implementations.

FIG. 3 is a flowchart representation of a method of saving game state information in accordance with some implementations.

FIG. 4 is a block diagram of a device that saves game state information in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

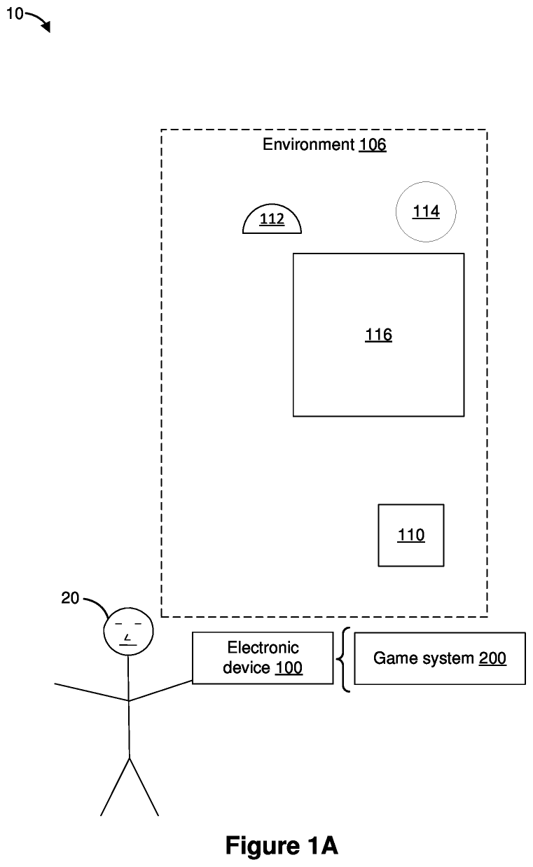

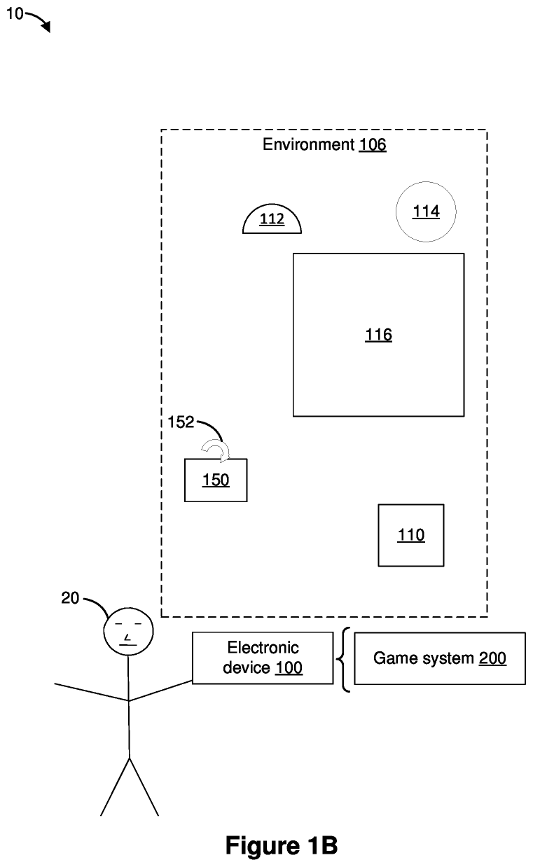

FIG. 1A is a block diagram of an example operating environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 10 includes an electronic device 100 and a game system 200. In some implementations, the electronic device 100 includes a handheld computing device that can be held by a user 20. For example, in some implementations, the electronic device 100 includes a smartphone, a tablet, a media player, a laptop, or the like. In some implementations, the electronic device 100 includes a wearable computing device that can be worn by the user 20. For example, in some implementations, the electronic device 100 includes a head-mountable device (HMD) or an electronic watch.

In the example of FIG. 1A, the game system 200 resides at the electronic device 100. For example, the electronic device 100 may implement the game system 200. In some implementations, the electronic device 100 includes a set of computer-readable instructions corresponding to the game system 200. Although the game system 200 is shown as being integrated into the electronic device 100, in some implementations, the game system 200 is separate from the electronic device 100. For example, in some implementations, the game system 200 resides at another device (e.g., at another electronic device, a controller, a server or a cloud computing platform).

As illustrated in FIG. 1A, in some implementations, the electronic device 100 presents an extended reality (XR) environment 106 that corresponds to (e.g., includes) a field of view of the user 20. In some implementations, the XR environment 106 is referred to as a computer graphics environment. In some implementations, the XR environment 106 is referred to as a graphical environment. In some implementations, the electronic device 100 generates the XR environment 106. In some implementations, the electronic device 100 receives the XR environment 106 from another device that generated the XR environment 106. In some implementations, the XR environment 106 includes some elements generated by the electronic device 100 and other elements received by the electronic device 100 from another device.

In some implementations, the XR environment 106 includes a virtual environment that is a simulated replacement of a physical environment. In some implementations, the XR environment 106 is synthesized by the electronic device 100. In such implementations, the XR environment 106 is different from a physical environment in which the electronic device 100 is located. In some implementations, the XR environment 106 includes an augmented environment that is a modified version of a physical environment. For example, in some implementations, the electronic device 100 modifies (e.g., augments) the physical environment in which the electronic device 100 is located to generate the XR environment 106 (e.g., by displaying virtual content overlaid on a video pass-through representation of the physical environment using an opaque display or on a view of the physical environment through an at least partially transparent display). In some implementations, the electronic device 100 generates the XR environment 106 by simulating a replica of the physical environment in which the electronic device 100 is located. In some implementations, the electronic device 100 generates the XR environment 106 by removing and/or adding items from the simulated replica of the physical environment in which the electronic device 100 is located. In some implementations, the XR environment 106 represents a communication session between the electronic device 100 and another electronic device. For example, the XR environment 106 may correspond to a video call between the electronic device 100 and the other electronic device.

In some implementations, the XR environment 106 includes various virtual objects such as an XR object 110 (“object 110”, hereinafter for the sake of brevity). In some implementations, the XR environment 106 includes multiple objects, such as XR objects 112, 114, and 116. In some implementations, the virtual objects are referred to as graphical objects or XR objects. In various implementations, the electronic device 100 obtains the objects from an object datastore (not shown). For example, in some implementations, the first electronic device 100 retrieves the object 110 from the object datastore. In some implementations, the virtual objects represent physical articles. For example, in some implementations, the virtual objects represent equipment (e.g., machinery such as planes, tanks, robots, motorcycles, etc.). In some implementations, the virtual objects represent fictional elements (e.g., entities from fictional materials, for example, an action figure or a fictional equipment such as a flying motorcycle). In some implementations, the virtual objects represent entities in a gaming environment, such as pieces or a board in a board game or characters or objects in a role-playing game.

In various implementations, the electronic device 100 (e.g., the game system 200) tracks a state of a game application as the game application is running Changes to the game state may be pushed to a game state subsystem (not shown in FIG. 1). The game state may include entity status information and presentation information. Entity status information may indicate respective statuses of entities in the game, such as pieces in a board game or characters and objects in a role-playing game. The entity status information may include, for example, positions and/or orientations of various character entities in a game. In some implementations, the entity status information indicates actions that the character entities are performing and/or actions that may be available to be performed by a character entity. In some implementations, the entity status information indicates objectives that the character entities are pursuing. In some implementations, the entity status information includes a resource counter, such as a health counter or an energy counter. In some implementations, the entity status information includes a turn indicator to indicate whether it is a character entity's turn to take an action in the game.

The game state may include presentation information that is used to present the game, e.g., render the game. For example, the presentation information may include texture maps. The presentation information may be generated, for example, based on the entity status information and/or based on metadata associated with the game. For example, the electronic device 100 may generate a rendering of a character entity based on a description of the character entity and/or based on a texture map of the character entity that is stored as metadata. In some implementations, the presentation information may not be saved each time the game state is saved.

As shown in FIG. 1B, an affordance 150 may be displayed in the XR environment 106. The user 20 may activate the affordance 150 to save the game. For example, the user may direct an input 152 to the affordance 150. The input 152 may include, for example, a touch input, a gesture input, a gaze input, a voice input, and/or an input provided via a device such as a stylus or a mouse.

In response to the affordance 150 being activated, the game state subsystem may determine whether all of the changes to the game state have been received by the game state subsystem. If so, the game state may be stored to a memory (not shown in FIG. 1).

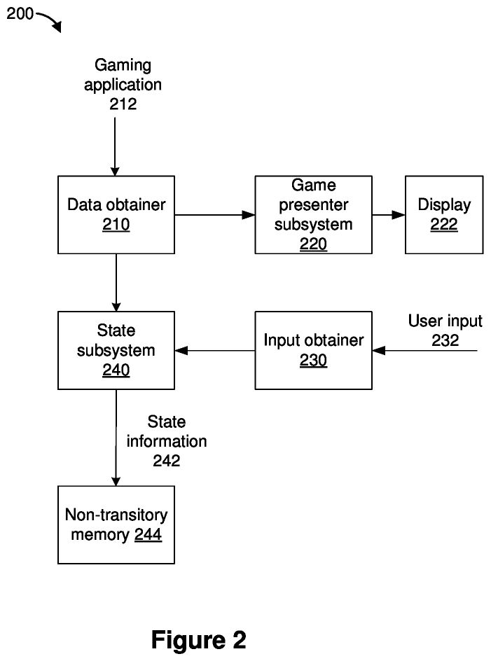

FIG. 2 is a block diagram of a game system 200 for tracking a state of a running game application and saving changes to a game state in accordance with some implementations. In various implementations, the game system 200 includes some or all of the components of the electronic device 100 in FIGS. 1A-1B. In some implementations, the game system 200 includes a peripherals interface, one or more CPU(s), and/or a memory controller for processing and storage resources.

In various implementations, the game system 200 or portions thereof are included in a device (e.g., the electronic device 100) enabled with a data obtainer 210 to obtain a gaming application 212 of the device. The CPU(s) may execute the gaming application 212 and may present the game to a user using a game presenter subsystem 220. For example, for a game of chess, the game presenter subsystem 220 may obtain three-dimensional (3D) models of the chess pieces, the shaders that are used to render the chess pieces, and information regarding where the pieces are positioned in the XR environment 106.

In some implementations, while the gaming application 212 is executing, the gaming application 212 may cause a user interface to be displayed in the XR environment 106, e.g., on a display 222. The user interface may include an affordance, such as the affordance 150 shown in FIG. 1B. In some implementations, the game system 200 includes an input obtainer 230 that detects a user input 232 directed to the affordance. For example, the input obtainer 230 may determine that the user is directing a gaze toward the affordance. As another example, the input obtainer 230 may determine that the user is performing a gesture directed toward the affordance, e.g., with an extremity or an auxiliary pointing device, such as a mouse or a stylus.

In some implementations, in response to detecting the user input 232, a state subsystem 240 may determine state information 242 for the gaming application 212. The state information 242 may include a first portion that indicates respective statuses of one or more entities associated with the gaming application that have changed since a previous save. For example, for a board game application, the first portion of the state information 242 may indicate the positions of various pieces on the board, which player has the current turn, etc. As another example, for a role-playing game application, the first portion of the state information 242 may indicate one or more actions that a character in the game is enabled to perform. In some implementations, the first portion of the state information includes one or more resource counters, such as a health counter, an energy counter, and/or an ammunition counter. In some implementations, the state subsystem 240 may select one or more entities for which status information is included or excluded from the state information 242.

The first portion of the state information may be stored to a data structure during execution of the gaming application 212. In some implementations, the first portion of the state information is stored periodically, e.g., at defined time intervals. In some implementations, the first portion of the state information is stored in response to an event, such as an entity moving or a change in a status of an entity.

In some implementations, the state subsystem 240 saves the first portion of the state information that indicates the respective changed statuses of the entity or entities in a non-transitory memory 244 as a representation of the gaming progress of the user. The state subsystem 240 may forgo saving a second portion of the state information. This second portion may include presentation information that is used to present the gaming application 212 using the display 222. The game state may include presentation information that is used to present the game, e.g., render the game. Because the presentation information may not change frequently during gameplay, the presentation information may not be stored in the non-transitory memory 244. Forgoing storage of the second portion of the state information may conserve storage resources and improve performance.

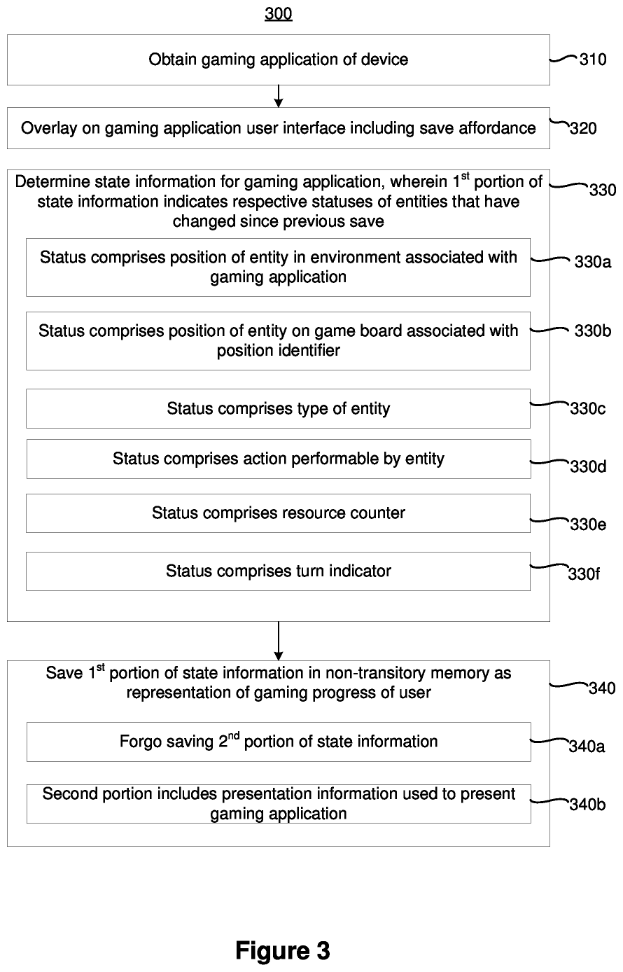

FIG. 3 is a flowchart representation of an example method 300 of saving game state information in accordance with some implementations. In various implementations, the method 300 is performed by a device (e.g., the electronic device 100 shown in FIGS. 1A-1B, or the game system 200 shown in FIGS. 1A-1B and 2). In some implementations, the method 300 is performed by processing logic, including hardware, firmware, software, or a combination thereof. In some implementations, the method 300 is performed by a processor executing code stored in a non-transitory computer-readable medium (e.g., a memory). In various implementations, an XR environment corresponding to a field of view of an image sensor (e.g., a scene-facing camera) of the device is displayed.

Briefly, the method 300 includes obtaining a gaming application of a device. While the gaming application is executed, a user interface that includes a save affordance may be overlaid on the gaming application. In response to detecting a user input directed to the save affordance, state information for the gaming application may be determined. A first portion of the state information may indicate respective statuses of one or more entities associated with the gaming application that have changed since a previous save. The first portion of the state information that indicates the respective changed statuses of the one or more entities as a representation of the gaming progress of the user may be saved in a non-transitory memory.

In various implementations, as represented by block 310, the method 300 includes obtaining a gaming application of the device. The gaming application may be obtained, for example, from a datastore via a wired or wireless network connection. In some implementations, the gaming application may be obtained via a physical medium, such as a memory device or an optical disc. The device may execute the gaming application 212 and may present the game to a user, for example, using a display. In some implementations, the device may obtain rendering information for use during runtime in rendering an environment associated with the gaming application. For example, for a game of chess, the device may obtain three-dimensional (3D) models of the chess pieces, the shaders that are used to render the chess pieces, and information regarding initial locations of the pieces in an XR environment.

In various implementations, as represented by block 320, the method 300 includes overlaying on the gaming application a user interface that includes a save affordance while executing the gaming application. For example, the save affordance may appear as a button in the field of view of the user. In some implementations, the save affordance may appear as an option in a menu. The method 300 may include detecting a user input directed to the save affordance. For example, a gaze input may be detected using user-facing cameras. A save operation may be initiated in response to determining that the user's gaze is directed to the save affordance. As another example, a world-facing camera may be used to detect a gesture performed by the user. The user may perform the gesture using an extremity or an auxiliary pointing device, such as a mouse or a stylus. In some implementations, the auxiliary pointing device communicates the user input to the device, e.g., by a wired or wireless connection.

In various implementations, as represented by block 330, the method 300 includes determining state information for the gaming application in response to detecting a user input directed to the save affordance. The state information may be accumulated during runtime and may be mirrored to a game state representation during a mirroring phase. In some implementations, the runtime state may be mirrored every frame. In some implementations, the runtime state may be mirrored before a save operation.

In some implementations, in a mirroring phase, objects may be created to represent entities in the game environment. The objects may be moved or deleted as the corresponding entities move.

In some implementations, manual mirroring may be performed. A game designer may select the intervals at which data is mirrored to a game state. For example, the complete state may be mirrored every frame. As another example, the complete state may be mirrored before a save operation. As another example, each object may be updated in the game state as the corresponding object changes in the runtime. For example, every time a piece on a chess board is moved, a corresponding game state object may be updated with new position information.

In some implementations, the user input may be used to specify one or more entities to include or exclude from the state information. For example, if a player leaves a multiplayer gaming application and their status is no longer relevant to the game, the save affordance may include an option to exclude that player's corresponding entity or entities in the game from being included in the state information.

A first portion of the state information may indicate respective statuses of one or more entities associated with the gaming application that have changed since a previous save. In some implementations, as represented by block 330a, the status of an entity may include a position of the entity in an environment associated with the gaming application. For example, in a role-playing game application, the status of a character entity may include a current location of the character in the game world. The location may be represented as coordinates in the game world (e.g., 3D coordinates) or as a descriptive location (e.g., “entrance of dungeon ABC”). In some implementations, as represented by block 330b, the status of an entity may include a position of the entity on a game board. The position may be associated with a position identifier. For example, in a chess application, the position of the entity may be represented using algebraic notation.

In some implementations, as represented by block 330c, the status of an entity may include a type of the entity. For example, some board games include pieces of different types; e.g., chess includes pawns, knights, bishops, castles, queens, and kings. As another example role-playing games include different types of characters, including player characters and non-player characters, and there are different types of non-player characters, such as different types of enemies.

In some implementations, an entity may be identified by a unique identifier that identifies the entity as differentiated from all other objects in the environment associated with the gaming application. The identifier may be assigned when an entity is created. The entity may have a number of constituent structures known as structs. Each struct may be associated with a struct type. Each struct type may have a fixed size and a number of constituent members. Each member may be associated with a name, a member type, and a fixed offset in a corresponding data section of the non-transitory memory. The data section may be a binary blob that represents the value of each member.

In some implementations, as represented by block 330d, the status of an entity may include an action that is performable by the entity. For example, different types of pieces in the game of chess can move in different ways. As another example, different types of characters in a role-playing game may be capable of different actions. For example, while a monster character may be able to attack, a villager character may lack this ability.

In some implementations, as represented by block 330e, the status of an entity may include a resource counter. Some examples of resource counters may include health (e.g., hit point) and energy (e.g., stamina or mana) counters, ammunition counters, wealth counters, and experience counters.

In some implementations, as represented by block 330f, the status of an entity may include a turn indicator. The turn indicator may indicate which player has a current turn in the game. For example, the status may be indicated as a binary value of 0 (not the player's turn) or 1 (the player's turn) or as a text value (e.g., “white”).

In various implementations, as represented by block 340, the method 300 includes saving, in a non-transitory memory, the first portion of the state information that indicates the respective changed statuses of the one or more entities as a representation of the gaming progress of the user. Saving the state information may involve serializing the state information to a binary buffer, e.g., writing the data for each object to the buffer. In some implementations, e.g., multiplayer implementations, runtime changes to the state information may be serialized and sent over a network to keep multiple clients in synchronization with each other.

In some implementations, as represented by block 340a, the device may forgo saving a second portion of the state information. As represented by block 340b, this second portion may include presentation information that is used to present the gaming application using a display. The game state may include presentation information that is used to present the game, e.g., render the game. Because the presentation information may not change frequently during gameplay, the presentation information may not be stored in the non-transitory memory. Forgoing storage of the second portion of the state information may conserve storage resources and improve performance.

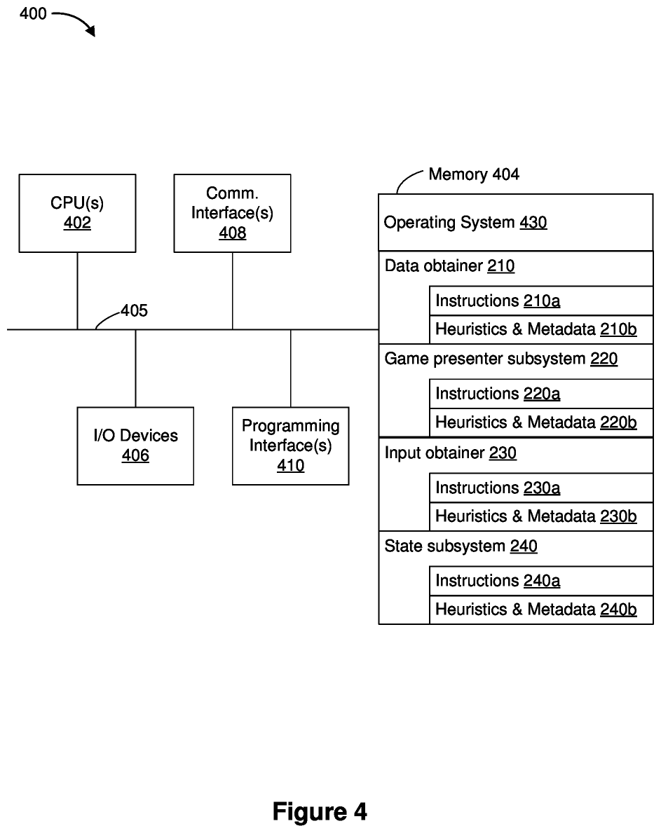

FIG. 4 is a block diagram of a device 400 in accordance with some implementations. In some implementations, the device 400 implements the electronic device 100 shown in FIGS. 1A-1B, and/or the game system 200 shown in FIGS. 1A-1B and 2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 402, a memory 404, one or more input/output (I/O) devices 406, one or more communication interfaces 408, one or more programming interfaces 410, and one or more communication buses 405 for interconnecting these and various other components.

In some implementations, the communication interface 408 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 402. The memory 404 comprises a non-transitory computer readable storage medium.

In some implementations, the memory 404 or the non-transitory computer readable storage medium of the memory 404 stores the following programs, modules and data structures, or a subset thereof including an optional operating system 430, the data obtainer 210, the game presenter subsystem 220, the input obtainer 230, and the state subsystem 240. In various implementations, the device 400 performs the method 300 shown in FIGS. 3A-3B.

In some implementations, the data obtainer 210 includes instructions 210a and heuristics and metadata 210b for obtaining a gaming application of the device. In some implementations, the game presenter subsystem 220 presents a game to a user, for example, using a display and/or an audio output device. The game presenter subsystem 220 may obtain information involved in rendering entities in the game. For example, for a game of chess, the game presenter subsystem 220 may obtain three-dimensional (3D) models of the chess pieces, the shaders that are used to render the chess pieces, and information regarding where the pieces are positioned in the XR environment 106. To that end, the game presenter subsystem 220 includes instructions 220a and heuristics and metadata 220b.

In some implementations, the input obtainer 230 causes the second text representation to be displayed on a display by compositing the second text representation onto video data representing the video content of a communication session to generate video output data that is output to the display. To that end, the text compositor 230 includes instructions 230a and heuristics and metadata 230b.

In some implementations, the state subsystem 240 determine state information for the gaming application. To that end, the state subsystem 240 includes instructions 240a and heuristics and metadata 240b.

In some implementations, the one or more I/O devices 406 include a user-facing image sensor (e.g., a front-facing camera) and/or a scene-facing image sensor (e.g., a rear-facing camera). In some implementations, the one or more I/O devices 406 include one or more head position sensors that sense the position and/or motion of the head of the user. In some implementations, the one or more I/O devices 406 include a display for displaying the graphical environment (e.g., for displaying the XR environment 106 shown in FIG. 1A). In some implementations, the one or more I/O devices 406 include a speaker for outputting an audible signal.

In various implementations, the one or more I/O devices 406 include a video pass-through display which displays at least a portion of a physical environment surrounding the device 400 as an image captured by a scene camera. In various implementations, the one or more I/O devices 406 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including one or more processors, a display, and a non-transitory memory:
obtaining a gaming application of the device;
while executing the gaming application, overlaying on the gaming application a user interface that includes a save affordance; and
in response to detecting a user input directed to the save affordance:
determining state information for the gaming application, wherein a first portion of the state information is stored to a data structure during execution of the gaming application and indicates respective statuses of one or more entities associated with the gaming application that have changed since a previous save; and
saving, in the non-transitory memory, the first portion of the state information that indicates the respective changed statuses of the one or more entities as a representation of the gaming progress of the user.

2. The method of claim 1, wherein a status of an entity associated with the gaming application comprises a position of the entity in an environment associated with the gaming application.

3. The method of claim 1, wherein a status of an entity associated with the gaming application comprises a position of the entity on a game board, and wherein the position of the entity is associated with a position identifier.

4. The method of claim 1, wherein a status of an entity associated with the gaming application comprises a type of the entity.

5. The method of claim 1, wherein a status of an entity associated with the gaming application comprises an action that is performable by the entity.

6. The method of claim 1, wherein a status of an entity associated with the gaming application comprises a resource counter.

7. The method of claim 1, wherein a status of an entity associated with the gaming application comprises a turn indicator.

8. The method of claim 1, further comprising forgoing saving a second portion of the state information.

9. The method of claim 8, wherein the second portion of the state information comprises presentation information that is used to present the gaming application using the display.

10. An electronic device comprising:
one or more processors;
a non-transitory memory;
a display; and
one or more programs, wherein the one or more programs are stored in the non-transitory memory and configured to be executed by the one or more processors, the one or more programs including instructions for:
obtaining a gaming application of the electronic device;
while executing the gaming application, overlaying on the gaming application a user interface that includes a save affordance; and
in response to detecting a user input directed to the save affordance:
determining state information for the gaming application, wherein a first portion of the state information is stored to a data structure during execution of the gaming application indicates respective statuses of one or more entities associated with the gaming application that have changed since a previous save; and
saving, in the non-transitory memory, the first portion of the state information that indicates the respective changed statuses of the one or more entities as a representation of the gaming progress of the user.

11. The electronic device of claim 10, wherein a status of an entity associated with the gaming application comprises a position of the entity in an environment associated with the gaming application.

12. The electronic device of claim 10, wherein a status of an entity associated with the gaming application comprises a position of the entity on a game board, and wherein the position of the entity is associated with a position identifier.

13. The electronic device of claim 10, wherein a status of an entity associated with the gaming application comprises a type of the entity.

14. The electronic device of claim 10, wherein a status of an entity associated with the gaming application comprises an action that is performable by the entity.

15. The electronic device of claim 10, wherein a status of an entity associated with the gaming application comprises a resource counter.

16. The electronic device of claim 10, wherein a status of an entity associated with the gaming application comprises a turn indicator.

17. The electronic device of claim 10, wherein the one or more programs include instructions for forgoing saving a second portion of the state information, the second portion of the state information comprising presentation information that is used to present the gaming application using the display.

18. A non-transitory computer readable storage medium storing one or more programs, the one or more programs comprising instructions, that, when executed by an electronic device with one or more processors and a display, cause the electronic device to:
obtain a gaming application of the electronic device;
while executing the gaming application, overlay on the gaming application a user interface that includes a save affordance; and
in response to detecting a user input directed to the save affordance:
determine state information for the gaming application, wherein a first portion of the state information is stored to a data structure during execution of the gaming application indicates respective statuses of one or more entities associated with the gaming application that have changed since a previous save; and
save, in the non-transitory memory, the first portion of the state information that indicates the respective changed statuses of the one or more entities as a representation of the gaming progress of the user.

19. The non-transitory computer readable storage medium of claim 18, wherein a status of an entity associated with the gaming application comprises at least one of the following: a position of the entity in an environment associated with the gaming application; a type of the entity; an action that is performable by the entity; a resource counter; and a turn indicator.

20. The non-transitory computer readable storage medium of claim 18, wherein the one or more programs include instructions for forgoing saving a second portion of the state information, the second portion of the state information comprising presentation information that is used to present the gaming application using the display.
